(19) United States
(12) Patent Application Publication
(10) Pub. No.: US 2014/0312803 A1
(43) Pub. Date: Oct. 23, 2014

(54) CIRCUIT FOR ACTUATING AN ILLUMINATION COMPONENT

(71) Applicant: OSRAM GmbH, Muenchen (DE)

(72) Inventor: Juergen Klier, Traunreut (DE)

(21) Appl. No.: 14/359,963

(22) PCT Filed: Sep. 27, 2012
(86) PCT No.: PCT/EP2012/069018

§ 371 Date: May 22, 2014

(30) Foreign Application Priority Data
Nov. 30, 2011 (DE) 10 2011 087 440.2

(51) Int. Cl. H05B 37/02

(52) U.S. Cl. CPC H05B 37/02
USPC 315/291

(57) ABSTRACT

A circuit for actuating an illumination component is disclosed. A control voltage for actuating the illumination component can be tapped off at a capacitor which can be charged via a charge current proportional to the voltage at the capacitor. The capacitor can be charged with a substantially exponential voltage profile at the capacitor via a first current mirror. The capacitor can be discharged via a second current mirror, the first current mirror and the second current mirror coupled, and the second current mirror provides, via this coupling, a coupling current which is proportional to a discharge current of the capacitor, and the first current mirror produces the charge current, which is substantially proportional to the coupling current.

### RELATED APPLICATIONS

The present application is a national stage entry according to 35 U.S.C. §371 of PCT application No.: PCT/EP2012/069018 filed on Sep. 27, 2012, which claims priority from German application No.: 102011087440.2 filed on Nov. 30, 2011, and is incorporated herein by reference in its entirety.

### TECHNICAL FIELD

Various embodiments relate to a circuit for actuating an illumination component and to a lighting system including a corresponding circuit.

### BACKGROUND

The term fading is used to describe a soft transition between different illumination levels. Such a transition is required, for example, in the case of comfort light controllers for cinema or theater or for daylight simulations, for example in the sphere of animal breeding or fishkeeping. An important demand that is placed on such a light controller is, in addition to the slow change in light, a profile of the light change which is perceived to be linear. Owing to the Weber-Fechner law, which states that the subjectively perceived intensity of sensory stimuli, as a proportional response to the logarithm of the objective intensity of the physical stimulus, and the predominantly linear profile of the characteristic of analog 1-10 V controllers, therefore an exponential response of a fading controller is required.

Such controllers have until now only been realized in a complex manner digitally, for example by means of a DALI controller.

### SUMMARY

Various embodiments provide an efficient solution for a comfort light controller.

In various embodiments, a circuit for actuating an illumination component is specified,
in which a control voltage for actuating the illumination component can be tapped off at a capacitor,
wherein the capacitor can be charged via a charge current, which is proportional to the voltage at the capacitor.

The present solution makes it possible to realize a fading functionality for a light controller with little complexity.

One development consists in that the capacitor can be charged with a substantially exponential voltage profile at the capacitor.

Another development consists in that
the capacitor can be charged via a first current mirror,
the capacitor can be discharged via a second current mirror,
wherein the first current mirror and the second current mirror are coupled, and the second current mirror provides, via this coupling, a coupling current which is proportional to a discharge current of the capacitor, and
wherein the first current mirror produces a charge current which is proportional to the coupling current.

In particular, a development consists in that a high-resistance resistor is arranged in parallel with the first current mirror and is connected to the capacitor.

By means of this resistor, a certain starting current can be provided which ensures recharging of the capacitor.

A further development consists in that the first current mirror is connected to the capacitor via a diode, wherein the cathode of the diode points in the direction of the capacitor.

In addition, a development consists in that the second current mirror is connected to the capacitor via a resistor.

In the context of an additional development, by means of the resistor and the capacitor, a fading time of the circuit can be set.

The fading time corresponds in particular to a time period for the exponential charge or discharge operation of the capacitor.

Another development consists in that the resistor is in the form of a variable resistor.

One configuration consists in that a dimming range is predeterminable by means of an input voltage, wherein the input voltage can be applied to the first current mirror.

An alternative embodiment consists in that the illumination component is at least one operating device for at least one lamp.

The operating device is also referred to as control gear. In particular, this may be an operating device for at least one gas discharge lamp and/or at least one fluorescent lamp. Additional mention is made of the fact that other lamps can also be actuated by means of corresponding operating devices.

Preferably, the operating device has an input, by means of which dimming can be set. This input can be actuated by means of the circuit explained here.

Another configuration consists in that a 1-10 volt control signal for the operating device can be provided by means of the circuit.

The abovementioned object is also achieved by a lighting system including the circuit explained here.

The lighting system may be an illumination unit, lamp, luminaire or combination of the above units.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows an exemplary schematic circuit arrangement which can be used, depending on an input signal, to achieve a light change which is subjectively perceived as uniform by means of an output signal, wherein the output signal can be applied, for example, to a 1-10 volt control input of an electronic operating device for a lamp;

FIG. 2 shows the signal profiles described here for the input signal at the circuit, the exponential profile of the voltage at the capacitor and the linear profile of a perceived brightness impression; and

FIG. 3 shows an exemplary circuit of a daylight circuit for illuminating an aquarium, for example.

### DETAILED DESCRIPTION

The following detailed description refers to the accompanying drawing that show, by way of illustration, specific details and embodiments in which the disclosure may be practiced.

An exponential profile of the control voltage is tapped off using a capacitor, which is discharged via a resistor because the discharge current is proportional to the voltage of the capacitor. The aim is to also configure the charging of the capacitor exponentially, i.e. to charge said capacitor with a current which is proportional to the capacitor voltage.

As mentioned at the outset, the object consists in specifying an efficient light controller, by means of which a soft transition between lighting levels (“fading”) can be achieved.

One demand that is placed on such a light controller consists, in addition to the slow change in light, in a profile of the light change that is perceived to be linear. On the basis of the Weber-Fechner law, accordingly the subjectively perceived intensity of sensory stimuli has a proportional response to the logarithm of the objective intensity of the physical stimulus and, owing to the predominantly linear profile of the characteristic of analog 1-10 V controllers, an exponential response of the fading controller is required for this.

The brightness of a lamp (or a plurality of lamps, a luminaire, a light-emitting module or a lighting system) can be reduced corresponding to the desired exponential curve by virtue of a control voltage for the 1-10 V controller being generated, which control voltage follows the normal discharge curve of a capacitor.

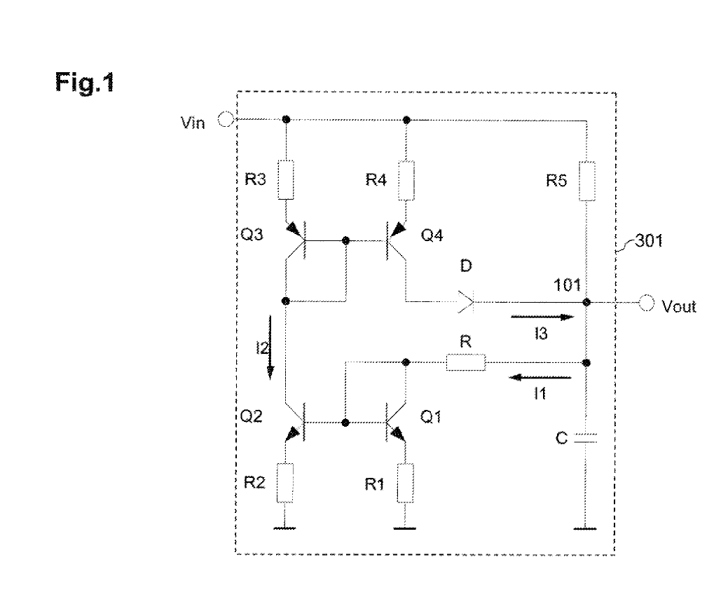

FIG. 1 shows an exemplary, schematic circuit arrangement, with the aid of which, depending on an input signal Vin, a light change which is perceived subjectively as uniform can be achieved by means of an output signal Vout. The output signal Vout can be applied, for example, to a 1-10 volt control input of an electronic operating device for a lamp.

The input signal Vin is present, via a resistor R3, at the emitter of a pnp transistor Q3, whose collector is connected to the collector of an npn transistor Q2 and to the base of the transistor Q3. The base of the transistor Q3 is furthermore connected to the base of a pnp transistor Q4. The input signal Vin is present, via a resistor R4, at the emitter of the transistor Q4, the collector of the transistor Q4 is connected to a node 101 via a diode D, wherein the cathode of the diode D points in the direction of the node 101. The output signal Vout can be tapped off at the node 101. In addition, the input signal is connected to the node 101 via a resistor R5.

The emitter of the transistor Q2 is connected to ground potential via a resistor R2. The base of the transistor Q2 is connected to the base and the collector of an npn transistor Q1. The emitter of the transistor Q1 is connected, via a resistor R1, to the ground potential. The collector of the transistor Q1 is connected to the node 101 via a resistor R. In addition, the node 101 is connected to the ground potential via a capacitor C.

The two transistors Q1 and Q2 are connected to one another in the form of a current mirror. The two transistors Q3 and Q4 also represent a current mirror.

As long as there is no input signal Vin present, the capacitor C is discharged by the resistor R. In the process, a current I1 which is approximately proportional to a voltage at the capacitor C flows.

In order that the brightness can be increased also corresponding to the desired exponential characteristic and the fading time for such an increase is equal to the fading time for a decrease in the light, as long as the input signal Vin=12 V is present a charge current I3 should be generated which is approximately twice as great as the discharge current I1. The current through the capacitor C is in this case I3-I1=I1 and is therefore again proportional to its voltage.

The current mirror Q1, Q2 produces, for this purpose, a current I2 which is proportional to the discharge current I1. The current mirror Q3, Q4 then produces the charge current I3, which for its part is proportional to the current I2. The desired ratio I3/I1=2 is achieved by virtue of the resistors being dimensioned corresponding to the following relationship

$$\frac{R 1}{R 2} \cdot \frac{R 3}{R 4} = 2.$$

When the capacitor C is completely discharged, no discharge current I1 is flowing anymore and therefore also no charge current I3 can be produced. This problem is solved by the resistor R5, which provides a certain starting current. Since this starting current distorts the exponential charge curve, the resistor R5 is preferably dimensioned to have as high a resistance as possible.

The diode D prevents undesired discharge of the capacitor C by the base-emitter paths of the transistors Q3 and Q4. The resistor R5 can be connected on both sides of the diode D.

When long fading times with a small capacitance of the capacitor C are intended to be achieved, low currents need to be evaluated. In this case, it is advantageous that this evaluation is performed by current mirrors because, as a result, the temperature and tolerance sensitivity of the circuit is minimized. Preferably double transistors are used, in which the entire current mirror is accommodated on a single chip.

The fading time is determined by the selection of the resistor R and the capacitor C. The fading time can be adjustable by virtue of, for example, the resistor R being implemented as a potentiometer.

Furthermore, for example, dimensioning of the resistors R1 to R4 in such a way that the following relationship applies

$$\frac{R 1}{R 2} \cdot \frac{R 3}{R 4} \neq 2$$

can result in different fading times for increasing and decreasing being realized.

As long as the input signal Vin is present at a level of approximately 12 V, the output voltage Vout increases exponentially in order ultimately to reach its maximum value of approximately 10 V. As soon as the input signal Vin is no longer present, Vout decreases exponentially down to approximately 0 V. The subjectively perceived brightness impression log Φ results in this case in the desired linear change.

If the intention is not for the entire dimming range to be passed through, this can be achieved by a narrower range of the input voltage Vin.

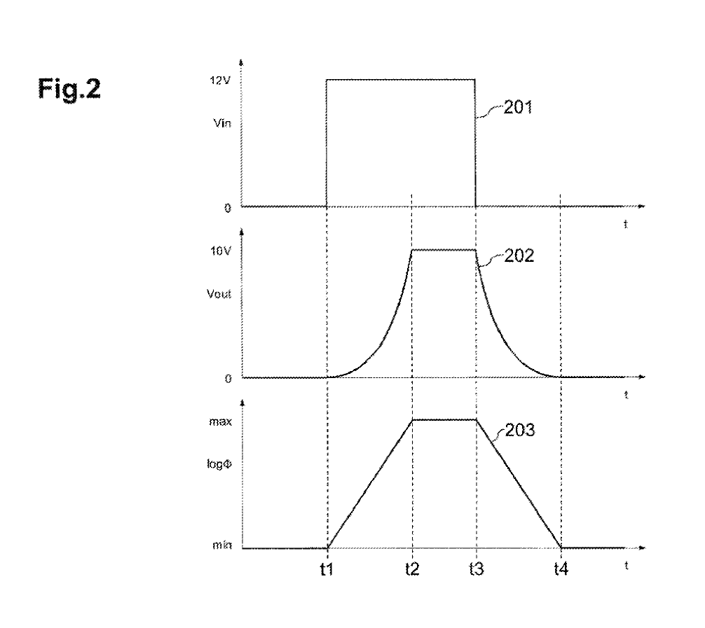

FIG. 2 illustrates the signal profiles described here. A signal profile 201 illustrates an exemplary input voltage Vin. At a time t1, the input voltage Vin is switched over from 0 volt to 12 volts, the voltage Vout 202 at the capacitor C increases exponentially up to a time t2, then the capacitor C is charged, the voltage Vout 202 remains constant. At a time t3, the input voltage 201 is switched back to 0 volt, and the voltage Vout 202 at the capacitor decreases exponentially up to a time t4.

If, depending on the profile 202 of the voltage Vout, a brightness impression 203 is considered, as it occurs when, for example, the signal Vout 202 is applied to a 1-10 volt input of an operating device for a lamp, a linear impression of the brightness change between times t1 and t3 and t3 and t4 results, and accordingly the light is uniformly dimmed.

### Application Example

### Daylight Simulation for Aquarium Illumination

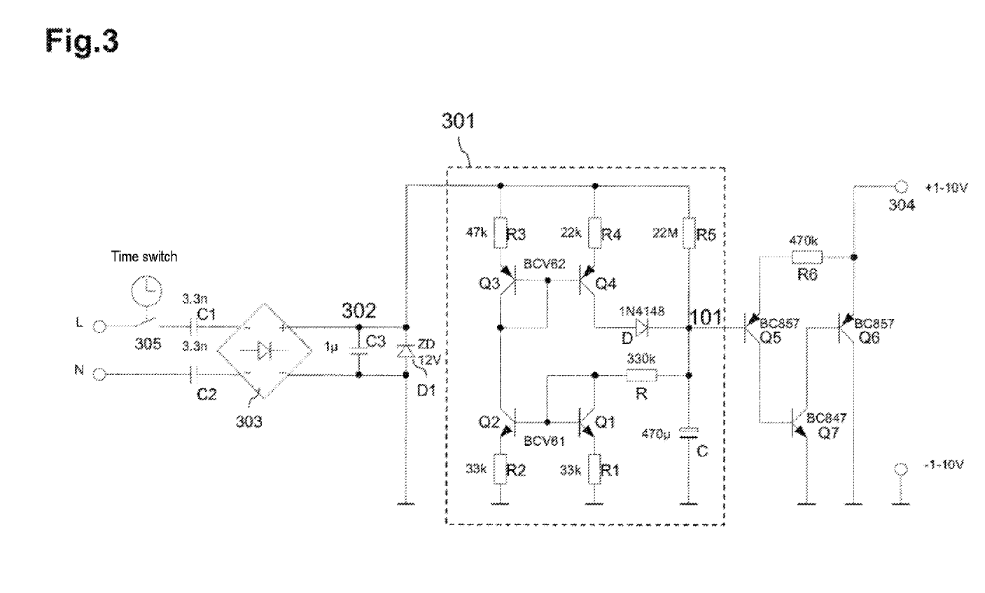

FIG. 3 shows an exemplary circuit of a daylight circuit for illuminating an aquarium, for example. A block 301 in this case includes the circuit illustrated in FIG. 1. The input signal Vin (cf. FIG. 1 with associated description) is provided via a node 302, and the output signal Vout is present at the node 101.

The L terminal of an AC mains voltage is connected to a rectifier 303 via a time switch 305 and a capacitor C1, and the N terminal of the AC mains voltage is connected to the rectifier 303 via a capacitor C2. The rectifier 303 provides a DC voltage, whose positive potential is connected to the node 302 and whose reference potential is connected to ground. The two DC voltage outputs of the rectifier 303 are connected to one another via a capacitor C3. A zener diode D1, whose cathode points in the direction of the node 302, is connected in parallel with the capacitor C3.

The node 101 is connected to the base of a pnp transistor Q5. The emitter of the transistor Q5 is connected to a node 304 via a resistor R6, and the collector of the transistor Q5 is connected to the base of an npn transistor Q7. The emitter of the transistor Q7 is connected to ground, and the collector of the transistor Q7 is connected to the base of a pnp transistor Q6. The collector of the transistor Q6 is connected to ground and the emitter of the transistor Q6 is connected to the node 304. A voltage which can be set so as to control a 1-10 volt input of an operating device for a lamp is present between the node 304 and the ground potential. An exemplary dimensioning or selection of the component parts can be performed as shown in FIG. 3.

The input signal Vin is produced at the node 302 by means of the time switch 305. The mains voltage provided via the terminals L and N can be stepped down, rectified and filtered in order thus to produce the input signal Vin. It is also possible to divide the mains voltage capacitively without using a transformer, as shown in FIG. 3; this is a particularly efficient solution owing to the low current consumption of the present circuit.

The output circuit including the three transistors Q5 to Q7 decouples the output (node 101) from the time-determining capacitor C in order to avoid charging by the control current which is provided by an operating device connected to the node 304 and to ground. This output circuit enables, for example, control of a plurality of, for example up to 10, operating devices (ECG units, electronic control gear units) without in the process the minimum output voltage of 1 V being overshot. If only one operating device is intended to be controlled, a pnp Darlington transistor can be used, for example.

This circuit has a fading time of 15 minutes and uses for this, as capacitor C, an electrolytic capacitor with a value of 470 μF.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A circuit for actuating an illumination component,
wherein a control voltage for actuating the illumination component can be tapped off at a capacitor,
wherein the capacitor can be charged via a charge current, which is proportional to the voltage at the capacitor,
wherein the capacitor can be charged with a substantially exponential voltage profile at the capacitor,
wherein the capacitor can be charged via a first current mirror,
wherein the capacitor can be discharged via a second current mirror,
wherein the first current mirror and the second current mirror are coupled, and the second current mirror provides, via this coupling, a coupling current which is proportional to a discharge current of the capacitor, and
wherein the first current mirror produces the charge current, which is substantially proportional to the coupling current.

2. The circuit as claimed in claim 1, wherein a high-resistance resistor is arranged between the first current mirror and the capacitor.

3. The circuit as claimed in claim 1, wherein the first current mirror is connected to the capacitor via a diode, wherein the cathode of the diode points in the direction of the capacitor.

4. The circuit as claimed in claim 1, wherein the second current mirror is connected to the capacitor via a resistor.

5. The circuit as claimed in claim 4, wherein, by means of the resistor and the capacitor, a fading time of the circuit can be set.

6. The circuit as claimed in claim 4, wherein the resistor is in the form of a variable resistor.

7. The circuit as claimed in claim 1, wherein a dimming range is predeterminable by means of an input voltage, wherein the input voltage can be applied to the first current mirror.

8. The circuit as claimed in claim 1, wherein the illumination component is at least one operating device for at least one lamp.

9. The circuit as claimed in claim 8, wherein a 1-10 volt control signal for the operating device can be provided by means of the circuit.

10. A lighting system comprising a circuit,
the circuit wherein a control voltage for actuating the illumination component can be tapped off at a capacitor,
wherein the capacitor can be charged via a charge current, which is proportional to the voltage at the capacitor,
wherein the capacitor can be charged with a substantially exponential voltage profile at the capacitor,
wherein the capacitor can be charged via a first current mirror,
wherein the capacitor can be discharged via a second current mirror,
wherein the first current mirror and the second current mirror are coupled, and the second current mirror provides, via this coupling, a coupling current which is proportional to a discharge current of the capacitor, and
wherein the first current mirror produces the charge current, which is substantially proportional to the coupling current.
